(19) United States
(12) Patent Application Publication
(10) Pub. No.: US 2016/0125878 A1
(43) Pub. Date: May 5, 2016

(54) VEHICLE AND HEAD UNIT HAVING VOICE RECOGNITION FUNCTION, AND METHOD FOR VOICE RECOGNIZING THEREOF

(71) Applicant: Hyundai Motor Company, Seoul (KR)

(72) Inventor: Kyu Hyung Lim, Yongin (KR)

(21) Appl. No.: 14/726,942

(22) Filed: Jun. 1, 2015

(30) Foreign Application Priority Data
Nov. 5, 2014 (KR) 10-2014-0152563

(51) Int. Cl. G10L 15/22; G10L 15/26

(52) U.S. Cl. CPC G10L 15/22; G10L 15/26; G10L 2015/223

(57) ABSTRACT

A vehicle having a voice recognition function includes: a wireless communication unit configured to wirelessly transmit and receive data; a voice recognition unit configured to convert a voice signal inputted from a particular user into a digital signal and to extract voice data from the digital signal; a text converter configured to convert the voice data into text; and a control unit configured to request and receive phonebook data from a mobile communication terminal in the vehicle when a wireless connection with the mobile communication terminal is recognized and to generate example data by combining the phonebook data with supplementary data expected to be inputted as a voice signal from a user and by deleting duplicate data in combinations of the phonebook data and the supplementary data.

### CROSS-REFERENCE TO RELATED APPLICATION(S)

This application claims the benefit of and priority to Korean Patent Application No. 10-2014-00152563, filed on Nov. 5, 2014 in the Korean Intellectual Property Office, the disclosure of which is incorporated herein by reference.

### BACKGROUND

1. Technical Field

Embodiments of the present disclosure relate to a vehicle and a head unit having voice recognition, and a voice recognition method thereof.

2. Description of Related Art

Various vehicle safety devices have been developed in consideration of a user's convenience and safety. Particularly, a head unit provides multimedia services, such as functions relating to audio, video, navigation, and the like, in a vehicle. The navigation functionality is configured to guide about a driver along a route to a destination selected by the driver and provide information about places around the destination. Meanwhile, the multimedia functionality may allow for connecting to a driver's or passenger's mobile communication terminal through wired or wireless communication.

As for using the mobile communication terminal, a call connection service initiated by a voice recognition function is typically provided for the safety of the passenger. The voice recognition functionality involves a technique of selecting an object having the largest similarity to a command list, which is subject to voice recognition, by converting the voice into data. The recognition performance and a recognition rate may vary according to the number of commands which are subject to recognition, as well as a method of combining various commands. Therefore, a processing method for performing voice recognition more efficiently may be needed.

### SUMMARY

It is an aspect of the present disclosure to provide a vehicle and a head unit having a voice recognition method configured to improve a voice recognition rate, in which a voice is inputted from a user, as well as a method for the voice recognition. Additional aspects of the present disclosure will be set forth in part in the description which follows and, in part, will be obvious from the description, or may be learned by practice of the disclosed embodiments.

In accordance with embodiments of the present disclosure, a vehicle having a voice recognition function includes: a wireless communication unit configured to wirelessly transmit and receive data; a voice recognition unit configured to convert a voice signal inputted from a particular user into a digital signal and to extract voice data from the digital signal; a text converter configured to convert the voice data into text; and a control unit configured to request and receive phonebook data from a mobile communication terminal in the vehicle when a wireless connection with the mobile communication terminal is recognized and to generate example data by combining the phonebook data with supplementary data expected to be inputted as a voice signal from a user and by deleting duplicate data in combinations of the phonebook data and the supplementary data.

The control unit may be further configured to delete a word having the same function as another word in a single combination of the combinations of the phonebook data and the supplementary data.

The word having the same function may be a duplicate word or a duplicate postposition when the voice data is in Korean.

The word having the same function may be a duplicate word or a duplicate preposition when the voice data is in English.

The control unit may be further configured to delete the same sentences in different combinations of the combinations of the phonebook data and the supplementary data.

The phonebook data may include commands in a form of a subject, and the supplementary data may include commands in a type of an object or a verb.

The control unit may be further configured to extract a command, which corresponds to the voice data, from the example data and to request a call to the mobile communication terminal based on the extracted command.

Furthermore, in accordance with embodiments of the present disclosure, a head unit having a voice recognition function includes: a wireless communication unit configured to wirelessly transmit and receive data; a voice recognition unit configured to convert a voice signal inputted from a particular user into a digital signal and to extract voice data from the digital signal; a text converter configured to convert the voice data into text; and a control unit configured to request and receive phonebook data from a mobile communication terminal in the vehicle when a wireless connection with the mobile communication terminal is recognized and to generate example data by combining the phonebook data with supplementary data expected to be inputted as a voice signal from a user and by deleting duplicate data in combinations of the phonebook data and the supplementary data.

The control unit may be further configured to delete a word having the same function as another word in a single combination of the combinations of the phonebook data and the supplementary data.

The words having the same function may be a duplicate word or a duplicate postposition when the voice data is in Korean.

The words having the same function may be a duplicate word or a duplicate preposition when the voice data is in English.

The control unit may be further configured to delete the same sentences in different combinations of the combinations of the phonebook data and the supplementary data.

Furthermore, in accordance with embodiments of the present disclosure, a voice recognition method includes: requesting or receiving phonebook data from a mobile communication terminal in a vehicle when the vehicle is wirelessly connected to the mobile communication terminal; combining the phonebook data and supplementary data expected to be inputted as a voice signal from a user; and generating example data by deleting duplicate data in combinations of the phonebook data and the supplementary data.

The generating of the example data may include deleting a word having the same function as another word in a single combination of the combinations of the phonebook data and the supplementary data.

The word having the same function may be a duplicate word or a duplicate postposition when the voice data is in Korean.

The word having the same function may be a duplicate word or a duplicate preposition when the voice data is in English.

The generating of the example data may include deleting the same sentences in different combinations of the combinations of the phonebook data and the supplementary data.

The phonebook data may include commands in a form of a subject, and the supplementary data may include commands in a type of an object or a verb.

The voice recognition method may further include converting a voice signal inputted from a user into a digital signal after generating the example data, extracting voice data from the digital signal, converting the extracted voice data into text, and extracting a command, which corresponds to the voice data, from the example data.

The voice recognition method may further include requesting a call to the mobile communication terminal based on the extracted command.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a view illustrating a relationship between components to provide a voice recognition service in a vehicle;

FIG. 2 is a block diagram illustrating a configuration of the vehicle in detail;

FIG. 3 is a block diagram illustrating a configuration of a control unit of FIG. 2;

FIGS. 4 to 7 are views illustrating a generating example data method according to embodiments of the present disclosure;

FIGS. 8 and 9 are views illustrating a generating example data method according to embodiments of the present disclosure;

FIG. 10 is a view illustrating a voice recognition method in the vehicle;

FIG. 11 is a block diagram illustrating a configuration of a head unit in detail; and

FIG. 12 is a flow chart illustrating a voice recognition method.

### DETAILED DESCRIPTION OF THE EMBODIMENTS

The present disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Like reference numerals in the drawings denote like elements, and thus their description will be omitted. In the description of the present disclosure, if it is determined that a detailed description of commonly-used technologies or structures related to the embodiments of the present disclosure may unnecessarily obscure the subject matter herein, the detailed description will be omitted. It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

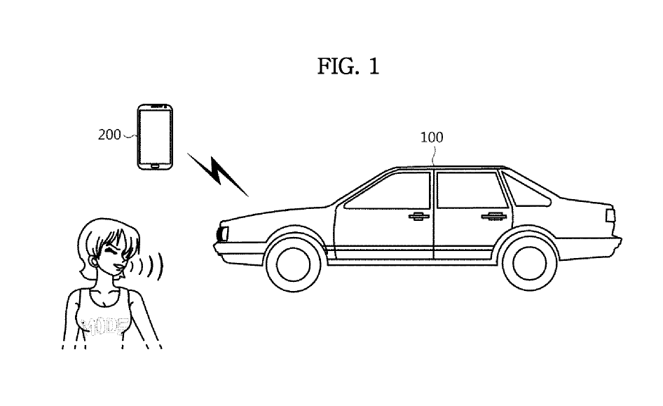

Referring now to the embodiments of the present disclosure, FIG. 1 is a view illustrating a relationship between components to provide a voice recognition service in a vehicle. As shown in FIG. 1, a vehicle 100 having a voice recognition function may request phonebook data by connecting to a mobile communication terminal 200 through wireless communication when a passenger having the mobile communication terminal 200 board the vehicle 100.

The vehicle 100 may download the phonebook data from the mobile communication terminal 200 and may generate example data having possibility expected to be inputted as a voice command from a user by combining the phonebook data and supplementary data expected to be inputted as a voice signal from a user, except for the phonebook data. To this end, the vehicle 100 may delete words having the same function in combinations from combinations of the phonebook data and the supplementary data, or may delete the same sentences in various combinations from combinations of the phonebook data and the supplementary data. Therefore, the example data may be sufficiently reduced. The vehicle 100 may also perform a call service by extracting a command from the example data based on a voice data inputted from a user.

The mobile communication terminal 200 may include a mobile phone, personal digital assistant (PDA), a smart phone, or other various portable terminals having a mobile communication function. The mobile communication terminal 200 may have unique identification, such as MAC address or Bluetooth Device Address (BD address), and the unique identification may be used for user authentication when a head unit is operated.

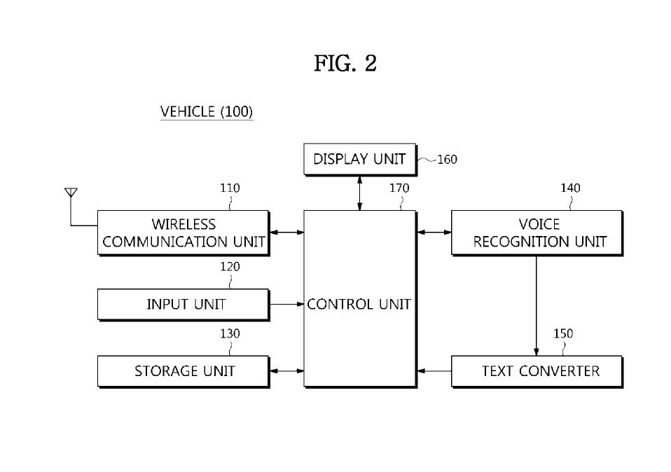

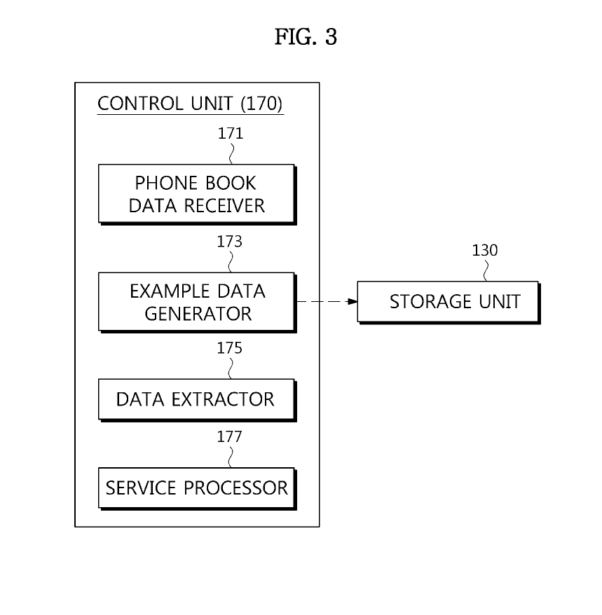

FIG. 2 is a block diagram illustrating a configuration of the vehicle in detail and FIG. 3 is a block diagram illustrating a configuration of a control unit of FIG. 2. As illustrated in FIG. 2, the vehicle 100 having a voice recognition function may include a wireless communication unit 110, an input unit 120, a storage unit 130, a voice recognition unit 140, a text converter 150, a display unit 160, and a control unit 170.

The wireless communication unit 110 may be configured to transmit/receive wireless data. The wireless communication unit 110 may be connected to the mobile communication terminal 200 placed in the vehicle 100 through wireless communication. Particularly, the mobile communication terminal 200 may be registered through user identification for security, but is not limited thereto.

The input unit 120 may be configured to input various control information for the vehicle 100, and may receive information of starting and terminating a head unit, selection information of an operating services in the head unit. When the display unit 160 is provided with a touch recognition function, control information may be inputted through the display unit 160. In addition, the control information may be inputted through buttons separately provided.

The head unit may be configured to provide various multimedia services including a navigation function in the vehicle 100. For example, the head unit may provide multimedia services relating to, for example, audio, video, and navigation, in the vehicle 100 for a driver of the vehicle 100 of convenience. The head unit may provide multimedia services by connecting to a mobile communication terminal of a passenger in the vehicle 100 through wireless communication.

The storage unit 130 may store supplementary data expected to be inputted through a voice signal from a user, example data and various data related to the vehicle 100. The voice recognition unit 140 may convert a voice signal inputted from a user into a digital signal, and may extract voice data from the digital signal. Although not shown, the vehicle 100 may be provided with a microphone to input a voice from a user.

In addition, the voice recognition unit 140 may transmit the extracted voice data to the text converter 150. The text converter 150 may convert the voice data into a text.

The display unit 160 may be configured to display various information related to the vehicle 100. For example, the display unit 160 may output guide information about a route, which is a navigation function, a title of music and an image according to operation of audio or video system, or various message related to operations of the vehicle 100.

The control unit 170 may request or receive phonebook data to or from the mobile communication terminal 200 when it is confirmed that wireless communication is connected, and may generate example data by combining the received phonebook data and supplementary data expected to be inputted as a form of a voice signal from a user. The control unit 170 may generate example data by deleting duplicate data from combinations of the phonebook data and the supplementary data. Particularly, the control unit 170 may include a phonebook data receiver 171, an example data generator 173, a data extractor 175, and a service processor 177.

When wirelessly receiving information from the mobile communication terminal 200 inside the vehicle 100 at the wireless communication unit 110, the phonebook data receiver 171 may transmit a signal to request phonebook data from the mobile communication terminal 200. The phonebook data receiver 171 may download phonebook data transmitted from the mobile communication terminal 200. At this time, the display unit 160 may display that the phonebook data is being downloaded, but is not limited thereto. The displaying that the phonebook data is being downloaded may be omitted.

The phonebook data may include contacts, such as names, nicknames, names of places, nicknames of places, etc., to distinguish contact information and phone numbers, but is not limited thereto. According to embodiments of the present disclosure, phonebook data used to generate example data may be a contact name.

The example data generator 173 may generate example data by combining the received phonebook data and supplementary data expected to be inputted as a form of a voice signal from a user. The example data generator 173 may also delete duplicate data from combinations of the phonebook data and the supplementary data. Particularly, the example data generator 173 may delete words having the same function in a single combination from combinations of the phonebook data and the supplementary data, or may delete the same sentences in different combinations to each other from combinations of the phonebook data and the supplementary data. The example data generator 173 may also generate data by separating a command, which corresponds to an object and a verb, based on postpositions. In the case of Korean, it is possible that various prefixes and suffixes are added to the same noun or verb. When generating example data, the same postposition added to each object and verb may appear duplicative and thus the same postposition may be invalid data. The valid data may not be actually used, but may be subject to be compared when recognizing voice. Therefore, the invalid data may cause misrecognition or reduce a voice recognition rate. As such, when generating example data, the number of generated data may be minimized by deleting duplicate postpositions so that a recognition rate may be improved.

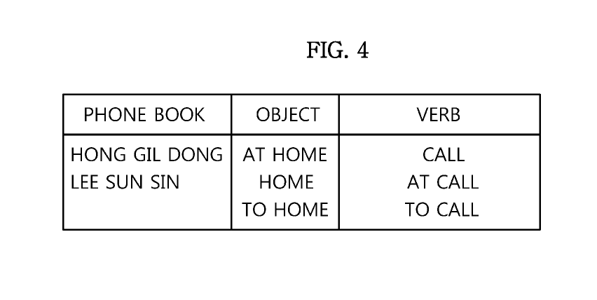

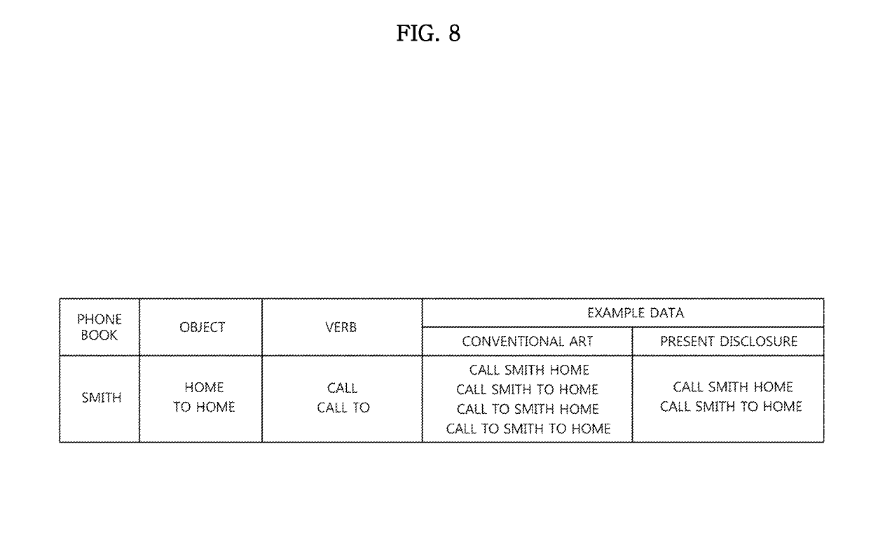

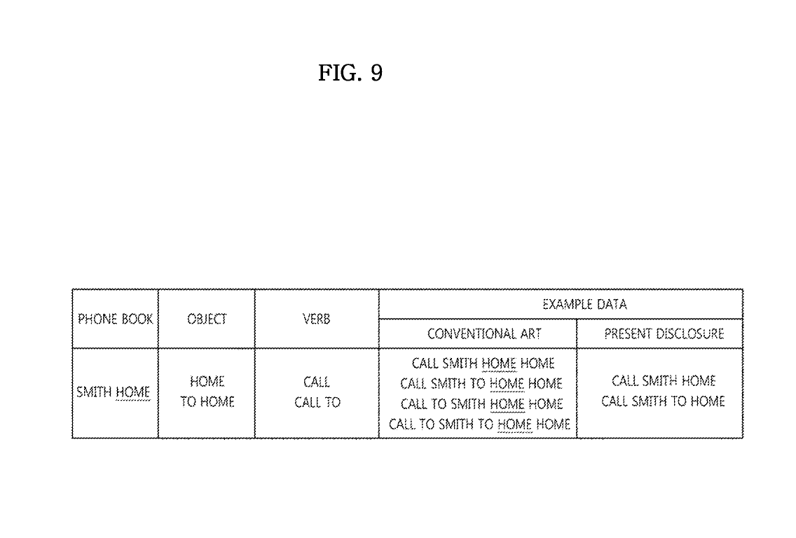

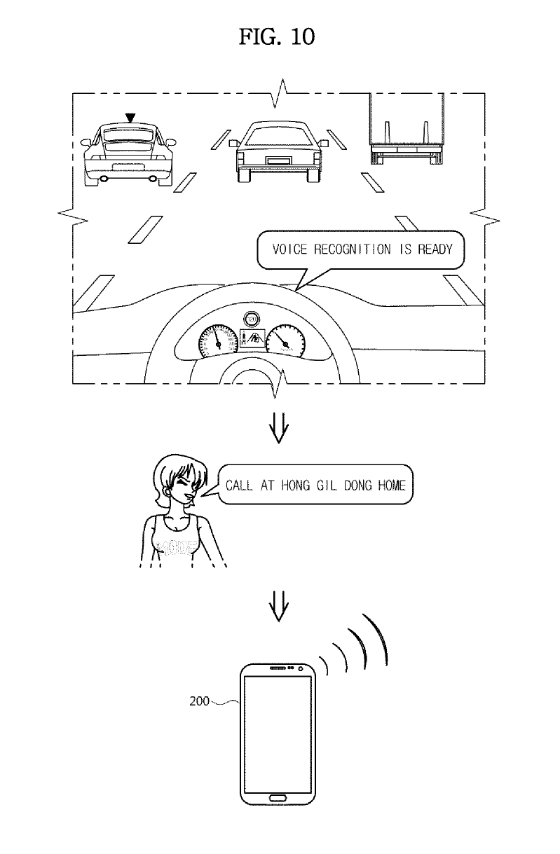

Hereinafter embodiments will be described with reference to FIGS. 4 to 7 illustrating a generating example data method according an embodiment of the present disclosure, FIGS. 8 and 9 illustrating a generating example data method according another embodiment of the present disclosure, and FIG. 10 illustrating a voice recognition method in the vehicle.

As illustrated in FIG. 4, phonebook data may include commands in a form of a subject, and supplementary data may include commands in a form of an object or a verb, but is not limited thereto. For example, phonebook data may be contact names, such as Hong gil dong, and Lee sun sin, an object in supplementary data may be “to home”, “home”, and a verb in supplementary may be “call”, “to call”. The supplementary data may be text, excluding phonebook data, expected to be told by a user when recognizing voice and may be stored in advance in the storage unit 130. Particularly, the example data generator 173 may combine phonebook data and supplementary data.

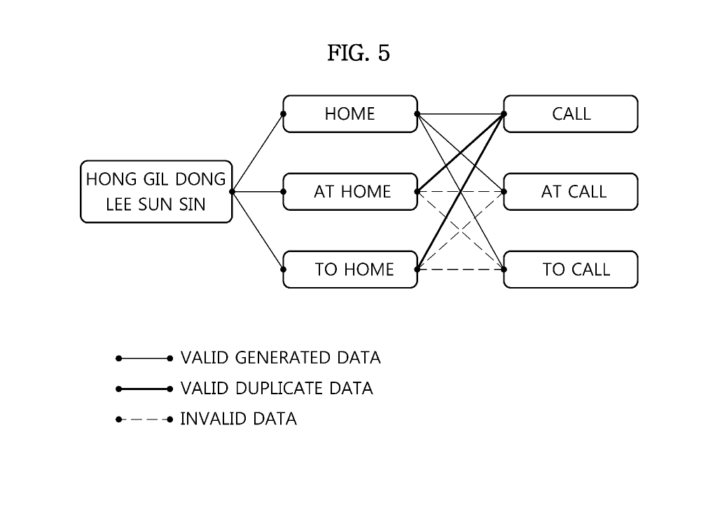

As illustrated in FIG. 5, eighteen combinations of the phonebook data and the supplementary data in total may be generated by combining of two of phonebook data (e.g., Hong gil dong, Lee sun sin), three of objects in the supplementary data (e.g., home, to home, for home), and three of verbs in the supplementary data (e.g., call, to call, for call). Plural objects and plural verbs are set because a command used by a user for the same motion to call may be various. such as “call to home”, “call home”.

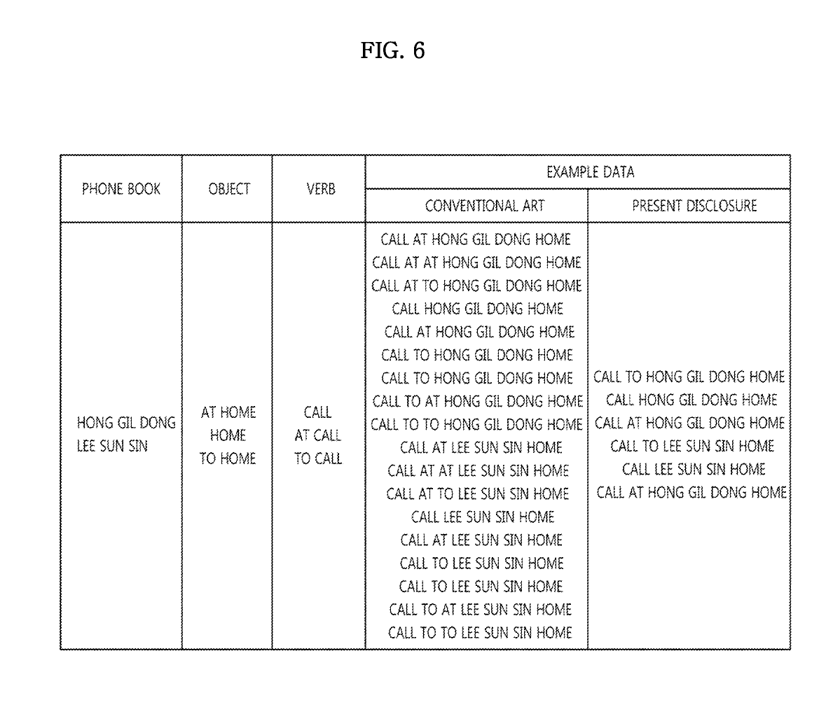

As illustrated in FIG. 6, a result of combining of two of phonebook data, three of objects in the supplementary data, and three of verbs in the supplementary data may generate valid-generated data, such as “call Hong gil dong home”, may generate invalid data, such as “call to Hong gil dong home”, or may generate valid-duplicate data. The invalid data and the valid-duplicate data may be a cause of delaying a command extraction time when comparing with voice data inputted from a user. Therefore, the example data generator 173 may delete words having the same function in a single combination in combinations of the phonebook data and the supplementary data. The example data generator 173 may delete the same sentence in different combinations in combinations of the phonebook data and the supplementary data. If voice data is in Korean, the words having the same function may be a duplicate word, or a duplicate postposition, but is not limited thereto.

Referring to FIG. 6, the example data generator 173 may generate example data (e.g., “call Hong gil dong home”, “call to Hong gil dong home”, “call at Hong gil dong home”, “call Lee sun sin home” “call to Lee sun sin home” “call at Lee sun sin home”, etc.) by deleting duplicate postpositions (e.g., to to, to at, at to, at at, etc.) or duplicate sentences among combinations (e.g., “call at Hong gil dong home”, “call at at Hong gil dong home”, “call at to Hong gil dong home” “call Hong gil dong home”, “call at Hong gil dong home”, “call to Hong gil dong home”, “call to Hong gil dong home”, “call to at Hong gil dong home”, “call to to Hong gil dong home”, “call at Lee sun sin home”, “call at at Lee sun sin home”, “call at to Lee sun sin home”, “call Lee sun sin home”, “call at Lee sun sin home”, “call to Lee sun sin home”, “call to Lee sun sin home”, “call to at Lee sun sin home”, “call to to Lee sun sin home”, etc.) of the phonebook data and the supplementary data. When the phonebook data includes an object as well as names, the example data generator 173 may prevent the object in the example data from being duplicated by deleting duplicate words.

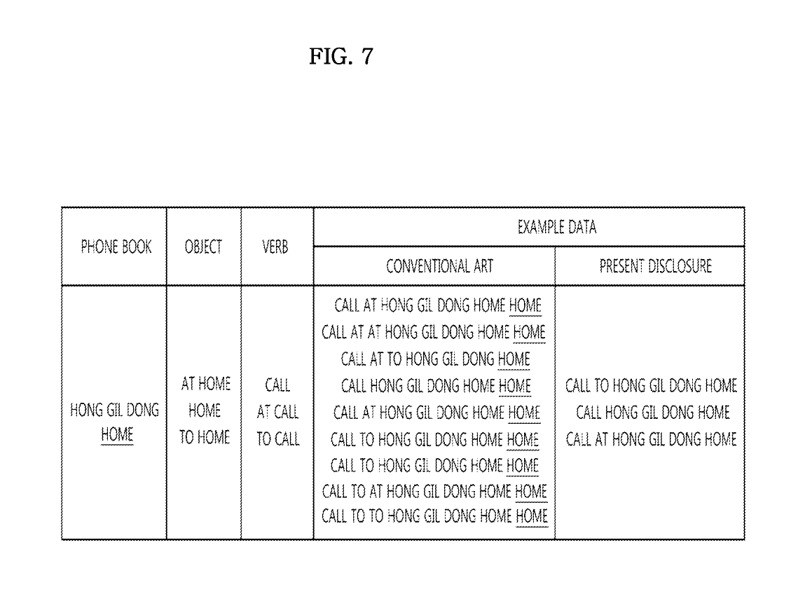

Referring to FIG. 7, the example data generator 173 may generate example data (e.g., “call Hong gil dong home”, “call to Hong gil dong home”, “call at Hong gil dong home”, etc.) by deleting duplicate postpositions or duplicate sentences among combinations (e.g., “call at Hong gil dong home”, “call at at Hong gil dong home”, “call at to Hong gil dong home” “call Hong gil dong home”, “call at Hong gil dong home”, “call to Hong gil dong home”, “call to Hong gil dong home”, “call to at Hong gil dong home”, “call to to Hong gil dong home”, etc.) of the phonebook data (e.g., Hong gil dong home, etc.) and objects in the supplementary data (e.g., at home, home, to home, etc.), and verbs in the supplementary data (e.g., call, call at, call to, etc.). When voice data is in English, words having the same function may be duplicate words or duplicate preposition, but is not limited thereto.

As illustrated in FIG. 8, the example data generator 173 may delete duplicate prepositions in combinations (e.g., “call smith home”, “Call smith to home”, “Call to smith home”, “Call to smith to home”, etc.) of the phonebook data and the supplementary data. The preposition deleted in the duplicate preposition may be set by a user according to English grammar.

As illustrated in FIG. 9, the example data generator 173 may delete duplicate words in combinations (e.g., “Call smith Home home”, “Call smith to Home home”, “Call to smith Home home”, “Call to smith to Home home”, etc.) of the phonebook data (e.g., Smith home, etc.), objects in the supplementary data (e.g., “home”, “to home”, etc.) and verbs in the supplementary data (e.g., “call”, “call to”, etc.). As mentioned above, the number of example data may be significantly reduced so that a period of time to compare voice data with the example data may be reduced. Therefore, a command may be quickly extracted. The data extractor 175 may extract example data corresponding to voice data from the example data as a command. The service processor 177 may request of connecting call to the mobile communication terminal 200 based on the extracted command.

For example, as illustrated in FIG. 10, the vehicle 100 may output a guide message in a text or in a voice, such as “voice recognition is ready”, on the display unit 160. When a user inputs voice, such as “call to Hong gil dong home”, the vehicle 100 may extract a command corresponding to an example data and may attempt to call using the mobile communication terminal 200.

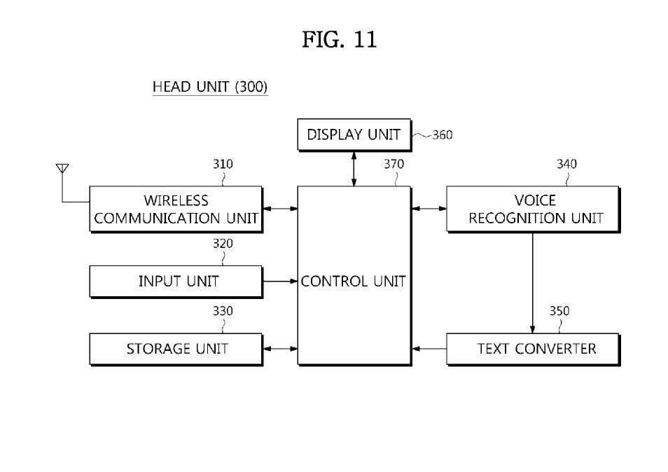

FIG. 11 is a block diagram illustrating a configuration of a head unit in detail. Hereinafter a description of the same parts as those shown in FIG. 2 will be omitted.

As illustrated in FIG. 11, a head unit 300 having a voice recognition function may be configured to provide multimedia services including a navigation function in the vehicle 100. The head unit 300 may include a wireless communication unit 310, an input unit 320, a storage unit 330, a voice recognizing unit 340, a text converter 350, a display unit 360, and a control unit 370.

For example, the head unit 300 may provide multimedia services, such as car audio function, a video function, and a navigation function, in the vehicle 100 for a driver of the vehicle 100 of convenience. In addition, the head unit 300 may provide services by connected to a mobile communication terminal of a user in the vehicle 100 by using wireless communication.

The wireless communication unit 310 may be configured to wirelessly receive/transmit data. The wireless communication unit 310 may be connected to the mobile communication terminal 200 placed in the vehicle 100 through wireless communication. The wireless communication unit 310 may be connected to the mobile communication terminal 200 registered through user identification for security, but is not limited thereto.

The input unit 320 may be configured to input various control information for the head unit 300, and may receive starting and terminating a head unit, selection information of operating services in the head unit. When the display unit 360 is provided with a touch recognition function, control information may be inputted through the display unit 360. In addition, control information may be inputted through buttons separately provided.

The storage unit 330 may store supplementary data expected to be inputted through a voice signal from a user, example data and various data related to the head unit 300. The voice recognition unit 340 may convert a voice signal inputted from a user into a digital signal, and may extract voice data from the digital signal. The voice recognition unit 340 may transmit the extracted voice data to the text converter 350. The text converter 350 may convert the voice data into a text.

The display unit 360 may be configured to display various information related to the head unit 300. For example, the display unit 360 may output guide information about a route, which is a navigation function, a title of music according to operation of audio or video system, or various message related to operations of the head unit 300.

The control unit 370 may request or receive a phonebook data to or from the mobile communication terminal 200 when it is confirmed that wireless communication is connected, and may generate example data by combining the received phonebook data and supplementary data expected to be inputted as a form of a voice signal from a user. The control unit 370 may generate example data by deleting duplicate data from combinations of the phonebook data and the supplementary data. The control unit 370 may delete words having the same function in combinations of the phonebook data and the supplementary data.

For instance, when the voice data is in Korean, the words having the same function may be duplicate words or duplicate postpositions, and when the voice data is in English, the words having the same function may be duplicate words or duplicate prepositions. The control unit 370 may delete the same sentences in different combinations of the phonebook data and the supplementary data.

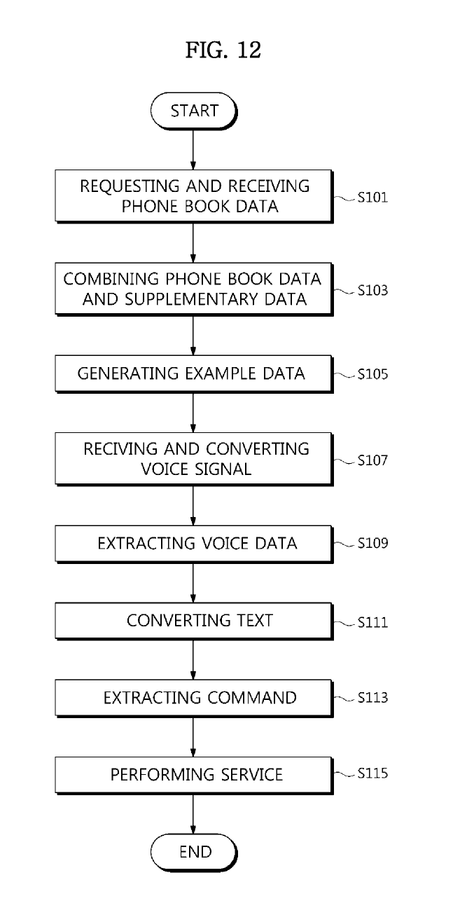

FIG. 12 is a flow chart illustrating a voice recognition method. As shown in FIG. 12, when connected to the mobile communication terminal 200 through wireless communication, the vehicle 100 may request or receive a phonebook data to or from the mobile communication terminal 200 (S101). The phonebook data may be a command in a form of a subject. The vehicle 100 may combine the phonebook data and supplementary data expected to be inputted as a voice signal from a user (S103). The supplementary data may be a command in a form of an object and a verb. The vehicle 100 may generate example data by also deleting duplicate data in combinations of the phonebook data and the supplementary data (S105).

At this time, the vehicle 100 may delete words having the same function in a single combination of the phonebook data and the supplementary data. For example, the vehicle 100 may delete a duplicate postposition, such as “at” in a sentence “call at at Hong gil dung home”. When the voice data is in Korean, the words having the same function may be duplicate words or duplicate postpositions. When the voice data is in English, the words having the same function may be duplicate words or duplicate prepositions. The vehicle 100 may delete the same sentence in different combinations of the phonebook data and the supplementary data. For example, when duplicate sentences are generated, such as “call to Hong gil dong home” and “call to Hong gil dong home”, the vehicle 100 may delete any one of them and may reduce the number of the example data.

Furthermore, the vehicle 100 may convert a voice signal inputted from a user into a digital signal (S107). Particularly, in a case when the vehicle 100 is ready to recognize a voice after generating example data is completed, the vehicle 100 may output a message, such as “voice recognition is ready”, as illustrated in FIG. 10. The vehicle 100 may receive voice from a user through a microphone (not shown). The vehicle 100 may extract a voice data from the digital signal (S109), and the vehicle 100 may convert the extracted voice data into a text (S111).

The vehicle 100 may extract a command from example data, wherein the command/example data corresponds to the voice data, which is converted into the text S113. At this time, the voice data corresponding to the example data may be the best match example with the voice data among the plurality of example data. The vehicle 100 may then request a call to the mobile communication terminal 200 based on the extracted command (S115).

The above-described voice recognition method may be executed when performing various services of the head unit, as well as when requesting a call by using a mobile communication terminal in a vehicle. As is apparent from the above description, according to the proposed vehicle and the head unit having voice recognition, and the voice recognition method thereof, when generating example data, which is used to compare with voice data inputted from a user, based on phonebook data of a mobile communication terminal, duplicate data may be deleted. Therefore, the number of the example data may be optimized so that a voice recognition rate may be improved

Although embodiments of the present disclosure have been shown and described above, it would be appreciated by those skilled in the art that changes may be made in these embodiments without departing from the principles and spirit of the disclosure, the scope of which is defined in the claims and their equivalents.

What is claimed is:

1. A vehicle having a voice recognition function, comprising:
a wireless communication unit configured to wirelessly transmit and receive data;
a voice recognition unit configured to convert a voice signal inputted from a particular user into a digital signal and to extract voice data from the digital signal;
a text converter configured to convert the voice data into text; and
a control unit configured to request and receive phonebook data from a mobile communication terminal in the vehicle when a wireless connection with the mobile communication terminal is recognized and to generate example data by combining the phonebook data with supplementary data expected to be inputted as a voice signal from a user and by deleting duplicate data in combinations of the phonebook data and the supplementary data.

2. The vehicle of claim 1, wherein:
the control unit is further configured to delete a word having the same function as another word in a single combination of the combinations of the phonebook data and the supplementary data.

3. The vehicle of claim 2, wherein:
the word having the same function is a duplicate word or a duplicate postposition when the voice data is in Korean.

4. The vehicle of claim 2, wherein:
the word having the same function is a duplicate word or a duplicate preposition when the voice data is in English.

5. The vehicle of claim 1, wherein:
the control unit is further configured to delete the same sentences in different combinations of the combinations of the phonebook data and the supplementary data.

6. The vehicle of claim 1, wherein:
the phonebook data includes commands in a form of a subject, and
the supplementary data includes commands in a form of an object or a verb.

7. The vehicle of claim 1, wherein:
the control unit is further configured to extract a command, which corresponds to the voice data, from the example data and to request a call to the mobile communication terminal based on the extracted command.

8. A head unit having a voice recognition function, comprising:
a wireless communication unit configured to wirelessly transmit and receive data;
a voice recognition unit configured to convert a voice signal inputted from a particular user into a digital signal and to extract voice data from the digital signal;
a text converter configured to convert the voice data into text; and
a control unit configured to request and receive phonebook data from a mobile communication terminal in the vehicle when a wireless connection with the mobile communication terminal is recognized and to generate example data by combining the phonebook data with supplementary data expected to be inputted as a voice signal from a user and by deleting duplicate data in combinations of the phonebook data and the supplementary data.

9. The head unit of claim 8, wherein:
the control unit is further configured to delete a word having the same function as another word in a single combination of the combinations of the phonebook data and the supplementary data.

10. The head unit of claim 9, wherein:
the word having the same function is a duplicate word or a duplicate postposition when the voice data is in Korean.

11. The head unit of claim 9, wherein:
the word having the same function is a duplicate word or a duplicate preposition when the voice data is in English.

12. The head unit of claim 8, wherein:
the control unit is further configured to delete the same sentences in different combinations of the combinations of the phonebook data and the supplementary data.

13. A voice recognition method, comprising:
requesting or receiving phonebook data from a mobile communication terminal in a vehicle when the vehicle is wirelessly connected to the mobile communication terminal;
combining the phonebook data and supplementary data expected to be inputted as a voice signal from a user; and
generating example data by deleting duplicate data in combinations of the phonebook data and the supplementary data.

14. The voice recognition method of claim 13, wherein the generating of the example data comprises:
deleting a word having the same function as another word in a single combination of the combinations of the phonebook data and the supplementary data.

15. The voice recognition method of claim 14, wherein:
the word having the same function is a duplicate word or a duplicate postposition when the voice data is in Korean.

16. The voice recognition method of claim 14, wherein:
the word having the same function is a duplicate word or a duplicate preposition when the voice data is in English.

17. The voice recognition method of claim 13, wherein the generating of the example data comprises:
deleting the same sentences in different combinations of the combinations of the phonebook data and the supplementary data.

18. The voice recognition method of claim 13, wherein:
the phonebook data includes commands in a form of a subject, and
the supplementary data includes commands in a form of an object or a verb.

19. The voice recognition method of claim 13, further comprising:
converting a voice signal inputted from a user into a digital signal after the generating of the example data;
extracting voice data from the digital signal;
converting the extracted voice data into text; and
extracting a command, which corresponds to the voice data, from the example data.

20. The voice recognition method of claim 19, further comprising:
requesting a call to the mobile communication terminal based on the extracted command.
